(19) United States
(12) Patent Application Publication
(10) Pub. No.: US 2015/0082337 A1
(43) Pub. Date: Mar. 19, 2015

(54) PIPELINED ENCRYPTION AND PACKETIZATION OF AUDIO VIDEO DATA

(71) Applicant: Broadcom Corporation, Irvine, CA (US)

(72) Inventors: Rajesh Shankarrao MAMIDWAR, San Diego, CA (US); Francis Chi-Wai Cheung, Del Mar, CA (US); Sanjeev Sood, San Diego, CA (US); Prashant Katre, San Diego, CA (US); Flaviu Dorin Turean, Palo Alto, CA (US); Anand Tongle, San Diego, CA (US); David ChaoHua Wu, San Diego, CA (US); Ming Chet Liew, Singapore (SG)

(73) Assignee: Broadcom Corporation, Irvine, CA (US)

(21) Appl. No.: 14/092,853

(22) Filed: Nov. 27, 2013

Related U.S. Application Data
(60) Provisional application No. 61/880,150, filed on Sep. 19, 2013.

(51) Int. Cl. H04N 21/2389; H04N 21/4627; H04N 21/236; H04N 21/2347; H04N 21/2365

(52) U.S. Cl. CPC H04N 21/23895; H04N 21/2347; H04N 21/23476; H04N 21/2365; H04N 21/23605; H04N 21/4627; H04N 21/23614
USPC 725/31

(57) ABSTRACT

A system for pipelined encryption and packetization of audio video (AV) data may consecutively encrypt a number of AV data units based on a security mechanism, associate the encrypted AV data units with a security header, where the security header is generated before the AV data units are encrypted, and the security header includes information related to the security mechanism, generate network packets for transporting the encrypted AV data units and the associated security header based at least in part on an order in which the AV data units are encrypted, where one or more of the network packets is generated contemporaneous with encrypting one or more of the AV data units, and provide the network packets for transport to a client device as the packets are generated, where the AV data units are encrypted and the network packets are generated without accessing memory external to the system.

### CROSS-REFERENCE TO RELATED APPLICATIONS

The present application claims the benefit of priority under 35 U.S.C. §119 from U.S. Provisional Patent Application Ser. No. 61/880,150 entitled “Pipelined Encryption And Packetization Of Audio Video Data,” filed on Sep. 19, 2013, the disclosure of which is hereby incorporated by reference in its entirety for all purposes.

### BACKGROUND

In home gateways, such as cable subscriber set top boxes (STBs) and the like, copy protection schemes such as Digital Transmission Content Protection over Internet Protocol (DTCP-IP) are used to protect content transmitted to receiving devices. As part of the encryption process, audio/video (AV) content may be stored and retrieved from memory multiple times. For example, when an AV stream is received by a home gateway the individual transport stream packets of the AV stream are temporarily stored in memory until they can be retrieved by software and packetized into one or more intermediary packets. The intermediary packets may then be stored again in memory where they are subsequently retrieved and encrypted, for example, based on the copy protection scheme. The host software then reorganizes these intermediary packets “in-memory” into packets compatible with a network protocol, such as Ethernet packets. This reorganization may again include multiple reads and writes to the memory to reorganize the packets, which may increase the latency associated with processing the AV stream as well as memory bandwidth for reading and writing data multiple times.

### BRIEF DESCRIPTION OF THE DRAWINGS

A detailed description will be made with reference to the accompanying drawings:

FIG. 1 illustrates an example network environment in which a system for pipelined encryption and packetization of AV data may be implemented in accordance with one or more implementations.

FIG. 2 illustrates an example network device that may implement a system for pipelined encryption and packetization of AV data in accordance with one or more implementations.

FIG. 3 illustrates example components of a network device implementing a system for pipelined encryption and packetization of AV data in accordance with one or more implementations.

FIG. 4 illustrates example AV data unit alignments in a system for pipelined encryption and packetization of AV data in accordance with one or more implementations.

FIG. 5 illustrates example AV data unit alignments for chunked encoding in a system for pipelined encryption and packetization of AV data in accordance with one or more implementations.

FIG. 6 illustrates a flow diagram of an example process of a system for pipelined encryption and packetization of AV data in accordance with one or more implementations.

FIG. 7 is a diagram illustrating an example electronic system for use in connection with encrypting and packaging AV data for transport in a network, including a processor and other related components.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced using one or more implementations. In one or more instances, structures and components are shown in block diagram form in order to avoid obscuring the concepts of the subject technology.

The subject technology provides a network device that includes a dedicated AV stream processor for efficiently processing and applying security mechanisms, such as copy protection, to AV streams requested by receiving devices. Multiple AV streams corresponding to a multimedia program may be received by the network device, decrypted, if necessary, and then multiplexed into a single multiplexed stream of AV data units. The stream of AV data units may then be passed to the AV stream processor where they are processed in an AV stream pipeline. In the AV stream pipeline, AV data units are encrypted as they are received, for example, according to a copy protection scheme, the encrypted AV data units are associated with a security header for the copy protection scheme, and internet protocol (IP) packets are consecutively generated for transport of the encrypted AV data units and security header in near real-time. The IP packets may be generated for the encrypted AV data units and security header based at least in part on the order in which the AV data units are encrypted. Thus, the AV stream pipeline allows the AV data units to be encrypted, associated with a header, and packetized for transport without requiring intermediary off-chip memory accesses, thereby substantially reducing the latency associated with processing the AV stream.

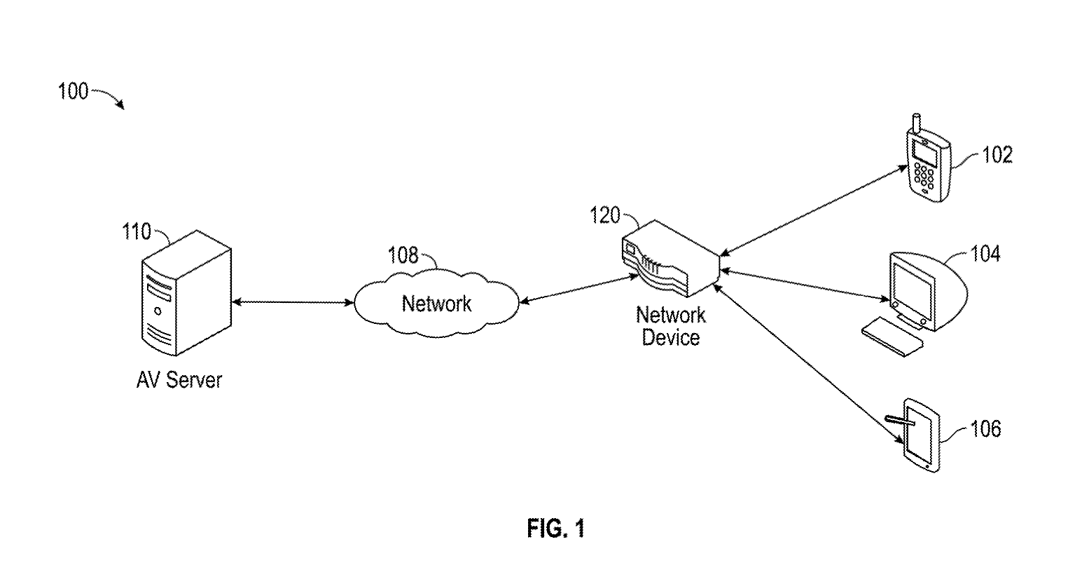

FIG. 1 illustrates an example network environment 100 in which a system for pipelined encryption and packetization of AV data may be implemented in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

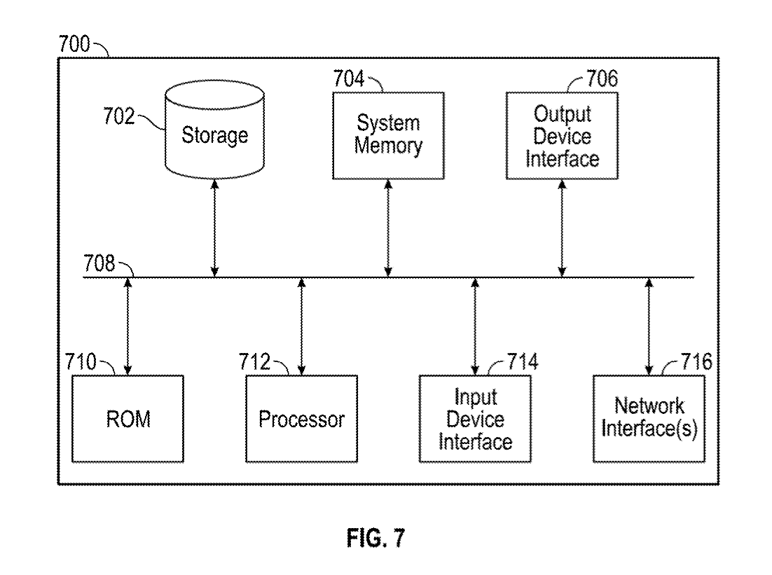

Example network environment 100 includes a content delivery network (CDN) 110 that is communicably coupled to network device 120, such as by a network 108. Example network environment 100 further includes one or more electronic devices 102, 104, 106 that are communicably coupled to network device 120, such as via a local area network (LAN). CDN 110, network device 120, and/or any of electronic devices 102, 104, 106, may be, or may include, one or more components of the electronic system discussed below with respect to FIG. 7. In one or more implementations, network device 120 may be, or may also include, a set-top box, for example, a device that is coupled to, and is capable of presenting AV programs on, an output device 124, such as a television, a monitor, speakers, or any device capable of presenting AV programs. In one or more implementations, network device 120 may be integrated into output device 124. Network device 120 may be a gateway device, such as a digital subscriber line (DSL) gateway, a cable modem gateway, or generally any gateway device.

CDN 110 may include, and/or may be communicably coupled to, an AV server 112, an antenna 116 for transmitting AV streams, such as via multiplexed bitstreams, over the air, and a satellite transmitting device 118 that transmits AV streams, such as via multiplexed bitstreams to a satellite 115. Network device 120 may include, and/or may be coupled to, a satellite receiving device 122, such as a satellite dish, that receives data streams, such as multiplexed bitstreams, from satellite 115. In one or more implementations, network device 120 may further include an antenna for receiving data streams, such as multiplexed bitstreams over the air from the antenna 116 of CDN 110. In one or more implementations, AV server 112 may transmit AV streams to network device 120 over the coaxial transmission network. In one or more implementations, network device 120 may receive internet protocol (IP) distribution via only one of antenna 116, satellite 115, or network 108.

Network 108 may be a public communication network (such as the Internet, cellular data network, dialup modems over a telephone network) or a private communications network (such as private local area network (“LAN”), leased lines). Network 108 may also include, but is not limited to, any one or more of the following network topologies, including a bus network, a star network, a ring network, a mesh network, a star-bus network, a tree or hierarchical network, and the like. In one or more implementations, network 108 may include one or more transmission networks, such as a coaxial transmission network, a fiber optic transmission network, or generally any transmission network that communicatively couples AV server 112 and network device 120.

AV server 112 may transmit data transmissions that include AV content items, such as television programs, movies, or generally any multimedia content, via network 108, such as by utilizing Data Over Cable Service Interface Specification (DOCSIS). In one or more implementations, network device 120 may receive internet protocol (IP) distribution of multimedia content via one of antenna 116, satellite 115, or network 108. For example, AV server 112 may transmit Internet Protocol (IP) streams, such as unicast, multicast, or broadcast streams, that include AV content items over network 108. In one or more implementations, any data transmissions that include AV streams and/or AV data, and/or are associated with AV streams and/or AV data, may be referred to as AV traffic (or AV network traffic), and any data transmissions that do not include, and/or are not associated with, AV streams and/or AV data may be referred to as non-AV traffic (or non-AV network traffic). In one or more implementations, any of the AV streams transmitted by AV server 112 may be, or may include, a transport stream that contains transport stream packets, such as an MPEG transport stream, an MPEG-2 transport stream, or generally any transport stream.

AV server 112 may include, or may be coupled to, one or more processing devices and/or a data store. The one or more processing devices execute computer instructions stored in the data store, for example, to transmit AV traffic. The data store may store the computer instructions on a non-transitory computer-readable medium. The data store may further store one or more AV content items that are transmitted by AV server 112. In one or more implementations, AV server 112 may be a single computing device such as a computer server. Alternatively, AV server 112 may represent multiple computing devices that are working together to perform the actions of a server computer (such as a cloud of computers and/or a distributed system). AV server 112 may be coupled with various databases, storage services, or other computing devices, that may be collocated with AV server 112 or may be disparately located from AV server 112.

Electronic devices 102, 104 and 106 can be computing devices such as laptop or desktop computers, smartphones, personal digital assistants (“PDAs”), portable media players, set-top boxes, tablet computers, televisions or other displays with one or more processors coupled thereto and/or embedded therein, or other appropriate computing devices that can be used for adaptive bit rate streaming, and rendering, of multimedia content and/or can be coupled to such a device. In the example of FIG. 1, electronic device 102 is depicted as a smart phone, electronic device 104 is depicted as a desktop computer, and electronic device 106 is depicted as a tablet device. In one or more implementations, any of electronic devices 102, 104, 106 may be referred to as a user device or a client device.

Network device 120 may be configured to couple electronic devices 102, 104, 106 to AV server 112 and/or to network 108. For example, network device 120 may receive requests for AV streams from electronic devices 102, 104, 106 and may forward the requests to AV server 112. In response to the requests, network device 120 may receive AV traffic from AV server 112 and may forward the AV traffic to one or more of electronic devices 102, 104, 106. In one or more implementations, network device 120 may be, or may include, a set-top box, for example, a device that can be coupled to an output device, such as a television, and is capable of presenting multimedia content via the output device. In one or more implementations, network device 120 may receive and/or retrieve AV data via one or more other connections (aside from network 108), such as via a coaxial connection, via an over-the-air antenna connection, via a satellite connection, via a local hard drive connection, and the like. Network device 120 may process the received and/or retrieved AV data, for example by decrypting, encrypting, and/or packetizing (e.g., bundling data into packets according to a specific protocol) the AV data, and may forward the processed AV data to one or more of electronic devices 102, 104, 106.

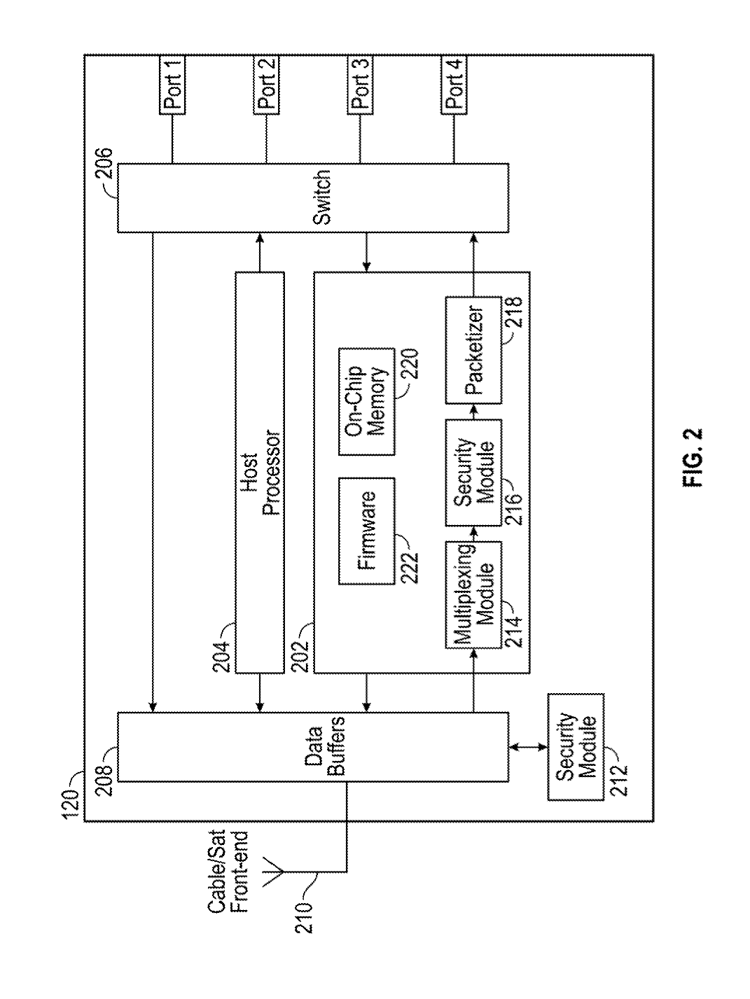

Network device 120 may include a host processor for processing non-AV traffic and a dedicated processor, along with associated hardware/firmware, that exclusively processes AV traffic, for example, an AV stream processor. In one or more implementations, network device 120 may include a network switch device that can be configured to route non-AV traffic to the host processor and AV traffic to the AV stream processor. Thus, in network device 120, AV traffic processing by the AV stream processor is decoupled from non-AV traffic processing by the host processor. An example network device 120 implementing the subject system, and an example operations thereof, are discussed further below with respect to FIGS. 2-6, respectively.

FIG. 2 illustrates an example network device 120 that may implement a system for pipelined encryption and packetization of AV data in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In the depicted example, network device 120 includes AV stream processor 202 for processing of AV data, and host processor 204 for processing non-AV data. Network device 120 may optionally include switch 206 for facilitating the transmission of processed AV network traffic to or from AV stream processor 202 and/or the transmission of processed non-AV network traffic to or from host processor 204.

As shown in FIG. 2, AV stream processor 202 may receive AV data from various sources. In one or more implementations, received AV data may be stored in one or more data buffers 208 and then retrieved by, or passed to, AV stream processor 202 from data buffers 208. Data buffers 208 buffer AV data originating from various sources including cable/satellite front-end 210, a network (e.g., operably connected to switch 206), and/or locally stored AV data, such as AV data stored on a hard drive associated with network device 120. Data buffers 208 may include one or more of hardware buffers, flash memory device, hard disk drive, solid state drive, or random access memory such as dynamic random access memory (DRAM) or Double data rate synchronous dynamic random-access memory (DDR SDRAM), and the like. Data buffers 208 may include a large amount of memory (e.g., several megabytes or gigabytes) or just enough memory to pass data through to AV stream processor 202 or host processor 204 in real time. For explanatory purposes, data buffers 208 are illustrated as a single block; however, data buffers 208 may include one or more separate data modules and/or may include one or more separate partitions thereof. In one or more implementations, data buffers 208 may represent off-chip memory, such as DRAM, that stores the AV data and on-chip memory, such as queues, that store descriptors of the AV data. In one or more implementations, host processor 204 may be prohibited, for example, physically or logically, from reading from and/or writing to data buffers 208.

In one or more implementations, AV content items may be received from a data source in a transport stream (TS) format such as MPEG transport stream. Each TS stream may include audio and/or video data packets, and other packets of other types of content intermingled in the stream. These TS packets may be generated by formatting AV data into AV data units, encrypting each AV data unit, and packaging the AV data units for transport over a network. The TS packets may be received by network device 120 from cable/satellite front-end 210, or from a network, for example, through switch 206.

In one or more implementations, network device 120 includes security module 212, for example, conditional access (CA) transport hardware, for decryption of received AV data. Incoming transport packets, including the encrypted AV data units, may be received and decrypted using the security module 212, such as by using one or more locally stored cipher keys, and the decrypted AV data units may be stored in data buffers 208. The decrypted AV data units may be subsequently retrieved (e.g., in real time) by AV stream processor 202. In one or more implementations, other components, modules, and/or buffers may facilitate receiving AV streams, for example, via cable/satellite front-end 210, decrypting AV streams and storing the AV data units of the AV streams in data buffers 208.

AV stream processor 202 may be implemented on a semiconductor chip, for example, as an integrated circuit packaged on a single die. In one or more implementations, AV stream processor 202 includes multiplexing module 214, pipeline security module 216, and packetizer 218 connected in series to form an AV stream pipeline (e.g., embedded within AV stream processor 202). On-chip memory 220 and firmware 222 provide operational support of the AV stream pipeline to facilitate encryption and packetization of AV data units in a single pass without using DRAM memory in between. Accordingly, multiplexing module 214 may receive AV data units (e.g., from data buffers 208 or directly from switch 206 or front-end 210), and process the AV data units within the pipeline without intermediary off-chip memory accesses. As will be described further, multiplexing module 214 may read multiple channels of AV data, for example, from data buffers 208, facilitate multiplexing of AV data units provided by those channels, and then pass the multiplexed AV data units to the AV stream pipeline for encryption and repackaging of the AV data units into a single multiplexed AV stream. In one or more implementations, AV stream processor 202 may include multiple AV stream pipelines such that multiple streams of AV data units may be received, encrypted, and packetized simultaneously.

Pipeline security module 216 is configured to encrypt or otherwise apply security to AV data units received from multiplexing module 214. Accordingly, pipeline security module 216 may include an encryption unit that encrypts or otherwise applies security to the data units received from multiplexing module 214. In one or more implementations, pipeline security module 216 also may include buffers for queuing the AV data units. In one or more implementations, pipeline security module 216 may encrypt AV data units based at least in part on a copy protection scheme. For example, AV data units may be encrypted into payloads of data and the encrypted payload paired with a security header to form a protected content packet (PCP).

Packetizer 218 is a portion of the AV stream pipeline configured to receive the encrypted AV data units from pipeline security module 216 and then packetize (e.g., package) the encrypted AV data units (e.g., encapsulate the data units in a payload and add headers to generate packets of data for transmission) into output IP packets, such as Ethernet packets. Packetizer 218 may include buffers for temporary storage of received AV data units prior to, during, or after the units have been packetized. Packetizer 218 may also include an output unit for distributing the packetized data units to a network, for example, by forwarding the packetized data units to switch 206.

In one or more implementations, packetizer 218 generates Ethernet frames to be transmitted by network device 120. In this regard, static header information corresponding to each channel for transmission may be stored in off-chip memory, such as DRAM, or in on-chip memory, such as on-chip memory 220. The static header information may include Ethernet header information, IP header information, and/or TCP/UDP/RTP header information. Packetizer 218 retrieves the static header information from memory, adds dynamic header information (e.g., sequence number, incremental timestamps, etc.), and packages AV payload data (e.g., forwarded to pipeline security module 216 in the AV stream pipeline or retrieved from DRAM) to generate an Ethernet frame for transmission. Thus, according to certain aspects, the subject system provides for a single framing stage, rather than multiple stages for each header. In one or more implementations, switch 206 may receive the packets of data from packetizer 218 and route the packets to their intended destinations.

In one or more implementations, switch 206 may route incoming and outgoing network packets to their intended destinations via one or more ports (e.g., shown in FIG. 2 as port 1, port 2, port 3, and port 4). The destinations may include one or more downstream client devices operably connected to network device 120, such as electronic devices 102, 104, 106, or any suitable computing device for receiving the AV network traffic. As depicted by FIG. 2, switch 206 may route incoming packets to data buffers 208, security module 212, AV stream processor 202, or host processor 204. In one or more implementations, switch 206 may route incoming packets through AV stream processor 202 and/or host processor 204 in order to provide the packets to data buffers 208 and/or security module 212. As described previously, switch 206 is optional and AV stream processor 202 and/or other components of network device 120 may route incoming and/or outgoing packets.

Although network device 120 is illustrated as including components for facilitating data flow from the processors 202, 204 to switch 206, it is understood that network device 120 may also include other components (not shown) for facilitating data flow in the opposite direction (e.g., from switch 206 to the processors). In one or more implementations, switch 206 may be integrated on-chip (e.g., on host processor 204).

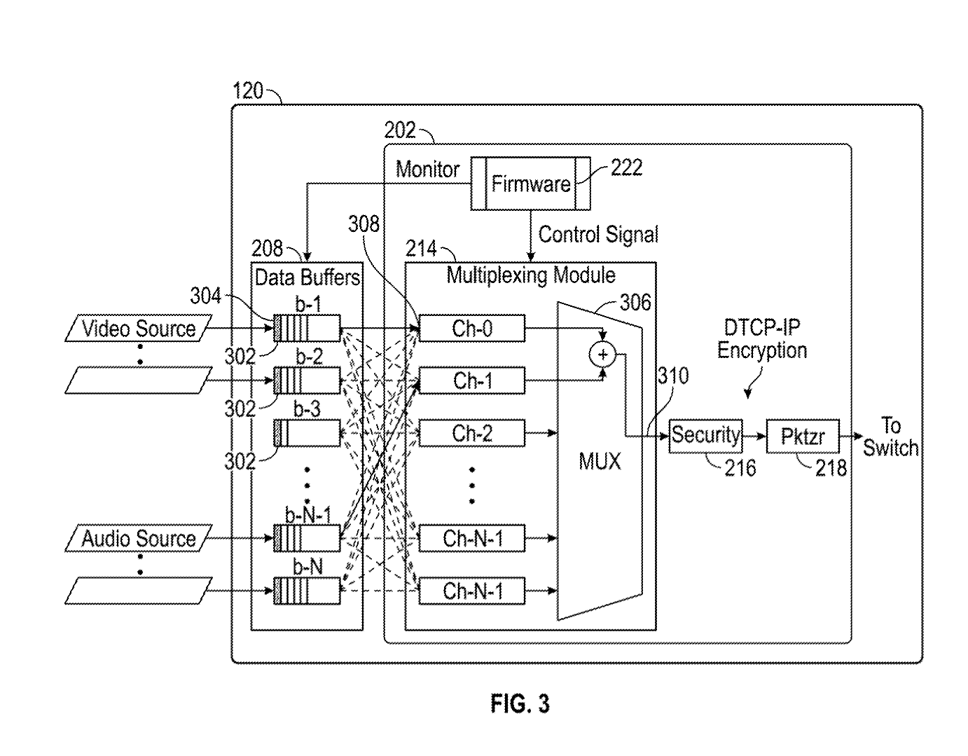

FIG. 3 illustrates example components of a network device 120 implementing a system for pipelined encryption and packetization of AV data in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In the depicted example, network device 120 includes AV stream processor 202, and data buffers 208. AV stream processor includes multiplexing module 214, pipeline security module 216, and packetizer 218. Multiplexing module 214 includes multiplexer 306, input data ports 308, and output data path 310. Data buffers 208 include one or more data buffers 302. In one or more implementations, the data buffers 302 may be data queues.

Multiplexing module 214 is coupled to data buffers 208 which store and/or receive AV data units intended to be transmitted to switch 206 (e.g., for subsequent routing to downstream devices). Data buffers 208 may be organized into separate data buffers 302 (b-1 to b-n). Data buffers 302 may represent intermediary storage locations in which AV data units are stored before multiplexing module 214 retrieves the AV data units and transmits them to a next stage (e.g., pipeline security module 216). Each data buffer 302 in data buffers 208 may be associated with a corresponding data source. Data sources include audio and video data sources, for example, audio or video encoders or decoders that encode or decode AV data, front-end 210, switch 206, or a local storage device (e.g., a hard drive). AV data may be received as encrypted TS packets from a data source, decrypted by security module 212, and then stored as unencrypted AV data units in a respective data buffer 302 of data buffers 208. In one or more implementations, control data 304 is added to the AV data units stored in each data buffer 302. The control data may identify, for example, a data format for the AV data unit(s) or associate the AV data unit(s) with an AV content item. In one or more implementations, the received TS packets may be stored in their encrypted form for multiplexing by multiplexer 306 and subsequent decryption by pipeline security module 216 within the AV stream pipeline.

Firmware 222 is a dedicated active agent that monitors data buffers 208 or other source of data at a given rate (e.g., every ms) to determine whether data is available in the data buffers 208 for processing by the AV stream pipeline. In one or more implementations, the given rate may be predetermined. Accordingly, firmware 222 may not need to be notified when data is available for processing by the AV stream pipeline. Firmware 222 controls multiplexing module 214 via one or more control signals and, in connection with multiplexing module 214, pipeline security module 216, packetizer 218, and other components of AV stream processor 202, facilitates selecting AV data units, multiplexing the AV data units, and encrypting the AV data units, as a single stream. AV data units may be selected based on control data 304, for example, such that the selected AV data units belong to the same AV content item. In this regard, multiplexing module 214 includes multiple input data ports 308 associated with respective multiplexer channels (e.g., Ch-1 to Ch-N). As depicted by FIG. 3, any input data port 308 may be dynamically paired with any selected data buffer 302 for retrieval of one or more AV data units.

Multiplexing module 214 is configured to read and pull unencrypted and/or encrypted AV data units from data buffers 302 of data buffers 208 or other data source at a given rate. Accordingly, each multiplexer channel of multiplexing module 214 may be configured to receive and buffer (e.g., in a packet buffer) AV data units received via the respective ones of input data ports 308. The AV data units for each respective multiplexer channel may make up a portion or more of an incoming transport stream. Multiplexer 306 is configured to multiplex AV data units received from one or more incoming transport streams (e.g., using multiple multiplexer channels) to generate a single stream of AV data units that may then be encrypted to a copy protection encryption standard and then transmitted to a client device in one or more IP packets, for example, Ethernet or other network packets. In this regard, each multiplexer channel may buffer AV data units until a threshold number of AV data units has been reached (e.g., a payload size of a IP packet), so that AV data units may be retrieved while multiplexer 306 outputs a multiplexed stream of AV data units (that includes, e.g., audio, video and other data for one or more AV content items) to output data path 310. In some aspects, the AV data units may be output at a data rate based on a distance between timing maturity event occurrences of the corresponding incoming transport stream.

In the depicted example, firmware 222 is configured to monitor data buffers 208 and identify one or more data buffers 302 b-1 and b-N−1 as containing unencrypted AV data units in the form of incoming transport packets for an AV content item that has been requested by a client device. The AV data units may be identified, for example, based on control data 304 embedded within the AV data units. Firmware 222 instructs multiplexing module 214 to retrieve and multiplex the identified AV data units from data buffers 302 b-1 and b-N−1 and pass the multiplexed AV data units to pipeline security module 216 for encryption.

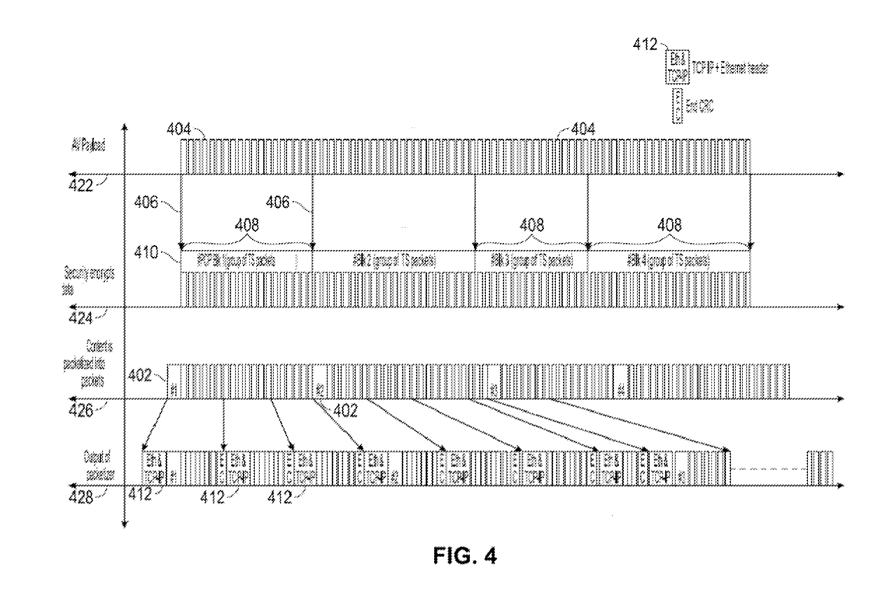

FIG. 4 illustrates example AV data unit alignments in a system for pipelined encryption and packetization of AV data in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

AV stream processor 202 operates to encrypt (and/or unencrypt) a stream of AV data units and assemble the data into a stream of IP packets for transmission to a client device. In this regard, AV stream processor 202 employs a pipelined processing mechanism (an “AV stream pipeline”) that encrypts AV data units according to a copy protection standard (e.g., DTCP-IP) and packages the encrypted AV data units 410 into IP packets (e.g., Ethernet packets) without utilization of any substantial external or on-chip memory. The AV stream pipeline is realized by multiplexing module 214, pipeline security module 216, and packetizer 218 (and other supporting components) operating as a series of pipeline stages on each AV data unit (e.g., in a stream of AV data units) as each AV data unit is sequentially passed to each stage.

As AV streams (e.g., audio and video streams associated with the same AV content item) are received from a content source (e.g., from AV server 112), network device 120 (e.g., security module 212) identifies incoming transport packets and, for each packet, identifies the type of packet and a key for descrambling the packet, and then descrambles the packet to generate a clear (unencrypted) AV data unit 404 which is stored in data buffers 208. In one or more implementations, unencrypted AV data units 404 are retrieved from data buffers 208 by multiplexing module 214, where the unencrypted AV data units 404 are multiplexed, reformatted and packetized into one or more AV payloads 408 which may be considerably larger in size (e.g., several kilobytes or megabytes each), spanning, for example, many AV data units 404 in length. In one or more implementations, encrypted AV data units 404 may be retrieved from data buffers 208, multiplexed, unencrypted by pipeline security module 216, and then reformatted and packetized into one or more AV payloads 408. An AV payload 408 may include AV data encrypted according to a digital rights management (DRM) technology such as Digital Transmission Content Protection Internet Protocol (DTCP-IP). The encrypted AV payload 408 is then reorganized into output IP packets compatible with a network protocol (e.g., an Ethernet packet). In one or more implementations, the network protocol may be predetermined. Network device 120 may include a network driver that feeds the output IP packets to network hardware (e.g., switch 206) for transmission to one or more client devices.

In MPEG encoding, for example, an AV data unit may be 188 bytes, 192 bytes, etc. On the other hand, content encrypted to DTCP standards is encrypted in 16 byte blocks, which are not even divisors of a single AV data unit. These 16 byte blocks may be encrypted using cipher block chaining in which an encrypted block of data is chained to the next encrypted block of data and so on, such that if one block is lost then the entire chain is lost. Cipher block chaining may create small overlaps of data when blocks spanning multiple AV payloads 408 (e.g., of several AV data units each) are encrypted.

AV payloads 408 are organized into corresponding protected content packets (PCPs). A PCP may include an AV payload 408 and a security header 402 (or “PCP header”). The security header 402 may, for example, include an initialization vector (including, e.g., a cipher key) for decoding blocks encapsulated within an encrypted payload of data in connection with a corresponding cipher key. In DCTP-IP, this initialization vector includes chaining information for encryption that is carried over from block to block. When a PCP is being prepared for transmission, the security header 402 is prepended to the corresponding AV payload 408 (e.g., at the front of the AV payload 408). When the PCP is decrypted, the initialization vector is extracted from the beginning of the packet and provided to a decryption engine for subsequent decryption of the individual data blocks within the packet. The decryption engine uses the initialization vector together with the corresponding cipher key (e.g., received in connection with the current decryption session) to decrypt the blocks within the AV payload 408 of the PCP.

With further reference to FIG. 4, the subject technology generates security headers 402 for insertion into a stream of unencrypted AV data units 404 received from multiplexing module 214 (e.g., in real time from a program broadcast) at intervals 406 in the stream. Each interval 406 may correspond to a number of unencrypted AV data units 404 that make up AV payload 408 for a PCP. Accordingly, each AV payload 408 may be dynamically encrypted according to a copy protection scheme (e.g., DTCP-IP) or other security mechanism and then reformatted into one or more output IP packets (e.g., Ethernet packets). In one or more implementations, the security headers 402, the intervals 406, and/or the number of unencrypted AV data units 404 that make up AV payload 408 may be predetermined. The encryption and reformatting is carried out in the AV stream pipeline, and therefore may be accomplished without requiring intermediary off-chip memory accesses during the process.

As described previously, the AV stream pipeline includes three primary stages. During a first stage, unencrypted AV data units 404 are retrieved by multiplexing module 214 to generate one or more AV payloads 408. The top line 422 of FIG. 4 illustrates a multiplexed stream of unencrypted AV data units 404 consecutively received into the AV stream pipeline from output data path 310 of multiplexing module 214.

In a second stage of the AV stream pipeline, unencrypted AV data units 404 are encrypted by pipeline security module 216, and then appended to a security header 402 to generate a corresponding PCP. The second line 424 of FIG. 4 illustrates how pipeline security module 216 encrypts and then groups consecutively received unencrypted AV data units 404 into AV payloads 408. Each AV payload 408 is sized to include a block of encrypted AV data units 410. Firmware 222 determines the length of an AV payload 408 based on the copy protection scheme to be used. In one or more implementations, since DTCP cipher block chaining encrypts in 16 byte blocks, the size of AV payload 408 may be set to either n*188*4 or 192 bytes so that AV payload 408 includes a complete cipher chain (e.g., (188*4)/16=47 and 192/16=12) of data units. Firmware 222 may instruct pipeline security module 216 to encrypt a number of unencrypted AV data units 404 using a cipher key provided by firmware 222 (e.g., from an external storage or on-chip memory 220). Accordingly, intervals 406 at which security headers 402 are inserted may be aligned to the size of AV payloads 408, for example, every n*188*4 or 192 bytes.

In one or more implementations, pipeline security module 216 does not wait for a complete AV payload 408 to be received to begin the encryption process but, rather, may consecutively encrypt each unencrypted AV data unit 404 as it is received into the AV stream pipeline. A block encryption chain may span multiple AV data units without having to store more than an individual block at one time. For example, a first AV data unit may be received into an encryption buffer of the AV stream pipeline. The cipher key (or initialization vector that includes the key) may be temporarily stored in a small buffer (e.g., in on-chip memory 220). If the size of the first AV data unit is not divisible by the size of the blocks within the unit to be cipher block chained then the cipher key may be used to encrypt all but a first portion of a trailing block in the first AV data unit. This first portion may also be stored in the small buffer. When a second AV data unit is received that includes a second portion of the trailing block, the first portion may be retrieved from the small buffer and combined with the second portion (e.g., prepended) of the second AV data unit within the encryption buffer. Accordingly, a chain of blocks may be encrypted as they are received from multiplexing module 214 according to a chain encryption standard without having to store more than a portion of a single 16 byte block in memory.

Firmware 222 and/or multiplexing module 214 may generate (e.g., precompile) security header(s) 402, including initialization vector for decryption of a complete block of AV data units, and provide the security header(s) 402 to pipeline security module 216 before encryption starts. Each security header 402 may include the number of bytes in the block of AV data units following it. Accordingly, as each unencrypted AV data unit 404 is encrypted, it is appended to the security header 402 and previously encrypted AV data units 410 forming each AV payload 408 to generate a complete PCP. The third line 426 of FIG. 4 illustrates how pipeline security module 216 appends security headers 402 to forms the PCPs.

In a third stage of the AV stream pipeline, packetizer 218 dynamically generates output IP packets from the component parts of PCPs. The fourth line 428 of FIG. 4 illustrates how the output IP packets may be consecutively generated for transmission concurrent with encrypting of the AV data units; so that each IP packet includes a consecutively encrypted group of one or more encrypted AV data units 410. Accordingly, firmware 222 may generate transport headers 412 (e.g., Ethernet headers) before encryption starts, in connection with receiving a stream of AV data units. In one or more implementations, the transport headers 412 may be predetermined and/or precompiled. Firmware 222 may keep track of the size of the PCP(s) to be generated, and use that size to generate transport headers 412. The size may be constant, or change over time. In one or more implementations, the size of each output IP packet may be considerably smaller than the size of a corresponding PCP. For example, while an encrypted payload of a PCP may be 128 k bytes, each output IP packet may be 1.3-1.5 k bytes.

Each transport header 412 includes the number of bytes and/or the number of AV data units included in the associated output IP packet. Transport header 412 is positioned at the front of an output IP packet. As each unencrypted AV data unit 404 is encrypted, it is assigned to a transport header 412. An encrypted PCP may not be evenly divisible into equally sized output IP packets. Since, in one or more implementations, the size of each output IP packet may be fixed, packetizer 218 may insert padding data to complete a IP packet. When AV stream processor 202 determines that enough data for a complete output IP packet has been appended to the packet (e.g., a complete packet is generated), the output IP packet is forwarded to the networking hardware to be transmitted to the client device.

It is understood that a stream of AV data units may be received into the AV stream pipeline and processed in real-time, with each stage concurrently operating on a different AV data unit in the stream. For example, an AV data unit may be encrypted by pipeline security module 216 concurrently with the insertion of a previously encrypted AV data unit 410 into an output IP packet by packetizer 218, and concurrently with the selection of a subsequent AV data unit by multiplexing module 214. In this manner, AV data units are consecutively encrypted, and IP packets for transmission of encrypted AV data units 410 consecutively generated based at least in part on an order in which the AV data units are encrypted.

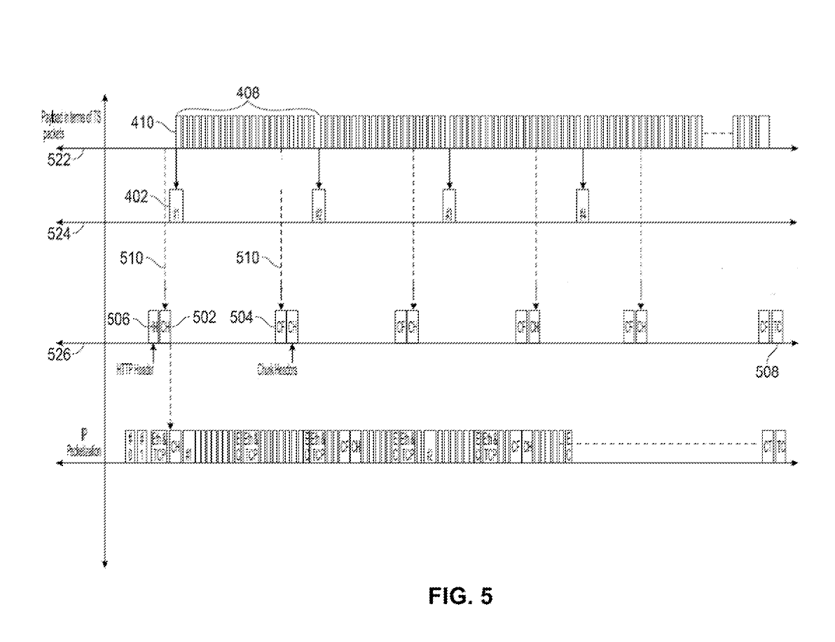

FIG. 5 illustrates example AV data unit alignments for chunked encoding in a system for pipelined encryption and packetization of AV data in accordance with one or more implementations. Not all of the depicted components may be required, however, and one or more implementations may include additional components not shown in the figure. Variations in the arrangement and type of the components may be made without departing from the spirit or scope of the claims as set forth herein. Additional components, different components, or fewer components may be provided.

In one or more implementations, the stream of encrypted AV data units 410 produced by pipeline security module 216 in the second stage of the AV data pipeline may be further chunk encoded before the encrypted AV data units 410 are packetized into output IP packets by packetizer 218. Accordingly, chunk headers 502 may be inserted within the stream at locations corresponding to respective chunked portions of the stream. The output IP packets are then generated for transmission of chunked portions comprising a number of encrypted AV data units 410 and the security header 402.

The first line 522 of FIG. 5 illustrates the alignment of security headers 402 between AV payloads 408 of encrypted AV data units 410 when PCPs are formed by pipeline security module 216. Firmware 222 generates security headers 402 for AV payloads 408 prior to the encrypting of the AV data units. Security headers 402 may be aligned at intervals 406 in the AV data pipeline, with consecutively encrypted AV data units 410 passing through the data pipeline to form a PCP when a group of the encrypted AV data units 410 is accumulated within the data pipeline at a position associated with a respective security header 402.

Packetizer 218 may be configured to generate chunk headers 502, chunk footers 504, HTTP headers 506, and in some aspects chunk trailers 508. The second line 524 of FIG. 5 illustrates how chunk headers 502 may also be generated and aligned in the AV stream pipeline by packetizer 218. Chunk headers 502 are inserted into AV pipeline stream at intervals 510, between chunks of encrypted AV data units 410 of a chunk size. In one or more implementations, the intervals 510 and/or the chunk size may be predetermined. The chunk size may be the same or different than the size of a PCP. For example, if an AV payload 408 is n*188*4 or 192 bytes then chunk headers 502 may be inserted into the AV stream pipeline between chunks of size m*188*4 or m*192 bytes, where m does not equal n. Firmware 222 may be configured to change the chunk size over a period of time, or keep the chunk sizes constant.

In one or more implementations, firmware 222 may generate an HTTP header 506 for a data connection between network device 120 and the client device. HTTP header 506 may be asserted only one time at the beginning of a transport stream sent to a client from network device 120. HTTP header 506 may include server and client information (e.g., internet addressing) in addition to information about how the stream is chunk encoded. Chunk trailers 508 may also be optionally set for a current AV stream.

The third line 526 of FIG. 5 illustrates the alignment of security headers 402 and chunk headers 502 within a series of AV data units output by the multiplexing module 214. In the depicted example, a chunk transfer may include multiple AV data units, which may not be aligned with each PCP to be transferred. Chunk headers 502 may be inserted, for example, in the middle of an AV payload 408. Accordingly, a chunked transfer may include a partial PCP, or one or more PCPs or partial PCPs.

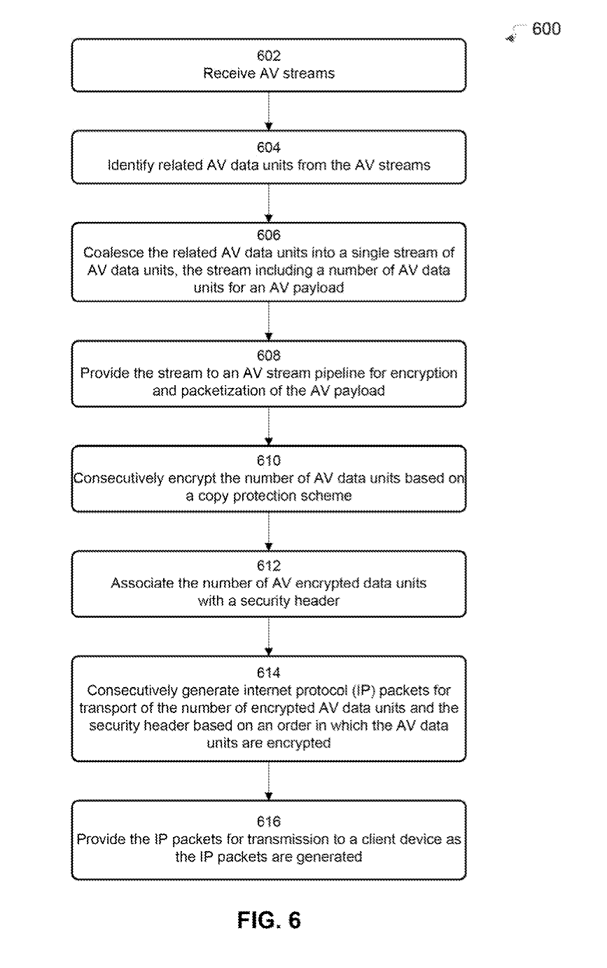

FIG. 6 illustrates a flow diagram of an example process 600 for pipelined encryption and packetization of AV data in accordance with one or more implementations. For explanatory purposes, example process 600 is described herein with reference to components of network device 120 of FIGS. 1-3; however, example process 600 is not limited to network device 120, and example process 600 may be performed by one or more other components of network device 120. Further for explanatory purposes, the blocks of example process 600 are described herein as occurring in serial, or linearly. However, multiple blocks of example process 600 may occur in parallel. In addition, the blocks of example process 600 need not be performed in the order shown and/or one or more of the blocks of example process 600 need not be performed. In one or more implementations, a non-transitory machine-readable medium may include machine-executable instructions thereon that, when executed by a computer or machine, perform example process 600. Accordingly, example process 600 may be performed by a streaming media system including, for example, one or more components of a set top box, cable modem, or gateway device, within the context of processing and/or providing AV data to a client device, such as electronic device 102.

AV streams are received by network device 120 (602). In one or more implementations, the AV streams may be received in real-time from, for example, a cable or satellite broadcast, the AV streams may be received from AV server 112, and/or the AV streams may be retrieved from a local storage device. In one or more implementations, AV data units that make up the data streams are stored in data buffers 302 of data buffers 208, and subsequently selected from data buffers 302 by multiplexing module 214 in near real-time to form a single multiplexed stream of AV data.

Accordingly, multiplexing module 214 may identify related AV data units within one or more different data buffers 302 (604), and then coalesce the related AV data units into a single multiplexed stream of AV data units (606), the stream including a number of AV data units for an AV payload 408. In this respect, the multiplexed stream may be provided to an AV stream pipeline for encryption and packetization (packaging into IP packets) of the AV payload (608).

The number of AV data units of each of the AV payloads 408 is then consecutively encrypted based at least in part on a security mechanism, such as a copy protection scheme (610). In one or more implementations, the copy protection scheme may include chain encrypting blocks of AV data within each AV data unit. For example, each data unit may include multiple blocks of data much smaller in size than the complete data unit. The blocks may be consecutively encrypted one block at a time, for example, to form a cipher block chain of block encryption such that the loss of one block would cause a decryption of the chain to fail.

In one or more implementations, the blocks of AV data in a single encryption chain may span multiple AV data units. In this regard, AV stream processor 202 may encrypt all but a first portion of a block of AV data in a first AV data unit (e.g., a partial block of a few bytes at the end of the AV data unit), and store the first portion in a buffer (e.g., in on-chip memory 220). On receiving a second AV data unit (e.g., in the multiplexed stream of AV data units) that includes the remaining portion of the first portion stored in the buffer, the first and remaining portions may be combined to form a complete data block. The complete data block may then be encrypted according to the copy protection scheme (e.g., the block may be the next block encrypted in the encryption chain).

The number of encrypted AV data units 410 of each AV payload 408 is associated with a security header 402 (612). According to one or more implementations, the security header 402 includes information for the copy protection scheme. For example, the security header 402 may include information for decrypting the AV data units in connection with a cipher key. Such information may include an initialization vector. In one or more implementations, the security header may be generated before the AV data units are encrypted. As described with regard to FIGS. 4 and 5, pipeline security module 216 may group consecutively received AV data units into AV payloads 408, and append the encrypted AV data units 410 to the security header 402 to generate a PCP. Pipeline security module 216 does not wait for a complete AV payload 408 to be received before associating the encrypted AV data units 410 with the security header 402 but, rather, may associate each AV data unit as it is encrypted.

IP packets are consecutively generated for transmission of the number of encrypted AV data units 410 of each AV payload 408, and the associated security header 402, as the AV data units of each AV payload 408 are encrypted, and based at least in part on an order in which the AV data units are encrypted (614). Accordingly, one or more IP packets may be generated for encrypted AV data units 410 that form a portion of an AV payload 408 contemporaneous with the encryption of one or more other AV data units that will become, once encrypted, another portion of the same AV payload 408. For example, one or more encrypted AV data units 410 in a first IP packet may be encrypted before one or more encrypted AV data units 410 in a second IP packet. In one or more implementations, the security header 402 that is associated with each of the encrypted AV data units 410 of the AV payload 408 is included in only one of multiple IP packets carrying the encrypted AV data units 410 of the AV payload 408.

IP packet headers may be generated for the IP packets prior to the encrypting of the AV data units, with each packet header providing information about a corresponding IP packet. In this regard, the IP packet headers may be aligned at (e.g., predetermined) locations in AV stream pipeline, with the consecutively encrypted AV data units 410 passing through the data pipeline to form a IP packet when a group of the encrypted AV data units 410 is accumulated within the data pipeline at a position associated with a IP packet header for the IP packet. In this manner, the AV data units may be encrypted and the plurality of IP packets generated by AV stream processor 202 without accessing memory external to AV stream processor 202 (e.g., DRAM or other off-chip memory).

The IP packets are provided for transmission to a client device as the IP packets are generated (616). In this manner, one or more encrypted AV data units 410 in a first IP packet may be encrypted before one or more encrypted AV data units in a second IP packet, and the first IP packet provided to the client device contemporaneous with the generation of the second IP packet. The IP packets may be provided, for example, to switch 206 for subsequent routing to a client device, such as electronic device 102.

In one or more implementations, the AV stream pipeline may contemporaneously perform one or more of the encrypting, packetizing, and transmitting stages with respect to the encrypted AV data units 410 of an AV payload 408 that are associated with a single security header 402. For example, a first IP packet that contains the security header 402 for an AV payload 408 and a first portion of the encrypted AV data units 410 of the AV payload 408 may be provided for transmission, and/or transmitted, contemporaneous with a second IP packet being generated for a second portion of the encrypted AV data units 410 of the AV payload 408, and further contemporaneous with the encryption of AV data units that will become, once encrypted, a third portion of the encrypted AV data units 410 of the AV payload 408. In one or more implementations, the AV stream pipeline may contemporaneously perform one or more of the encrypting, packetizing, and transmitting stages with respect to encrypted AV data units 410 across multiple AV payloads 408.

FIG. 7 is a diagram illustrating an example electronic system 700 for use in connection with encrypting and packaging AV data for transport in a network, including a processor and other related components, in accordance with one or more implementations of the subject technology. Electronic system 700, for example, is representative of the computing hardware embedded within, integrated with, or for providing functional operation of, the previously described systems and operations, including network device 120 and/or the process 600 of FIG. 6. In one or more aspects, electronic system 700 may be a desktop computer, a laptop computer, a tablet computer, a server, a switch, a router, a base station, a receiver, a phone, a personal digital assistant (PDA), or generally any electronic device that transmits signals over a network. Such an electronic system includes various types of computer readable media and interfaces for various other types of computer readable media. Electronic system 700 includes bus 708, processing unit(s) 712, system memory 704, read-only memory (ROM) 710, permanent storage device 702, input device interface 714, output device interface 706, and network interface 716, or subsets and variations thereof.

Bus 708 collectively represents all system, peripheral, and chipset buses that communicatively connect the numerous internal devices of electronic system 700. In one or more implementations, bus 708 communicatively connects processing unit(s) 712 with ROM 710, system memory 704, and permanent storage device 702. From these various memory units, processing unit(s) 712 retrieves instructions to execute and data to process in order to execute the processes of the subject disclosure. The processing unit(s) can be a single processor or a multi-core processor in different implementations.

ROM 710 stores static data and instructions that are needed by processing unit(s) 712 and other modules of the electronic system. Permanent storage device 702, on the other hand, is a read-and-write memory device. This device is a non-volatile memory unit that stores instructions and data even when electronic system 700 is off. One or more implementations of the subject disclosure use a mass-storage device (such as a magnetic or optical disk and its corresponding disk drive) as permanent storage device 702.

Other implementations use a removable storage device (such as a floppy disk, flash drive, and its corresponding disk drive) as permanent storage device 702. Like permanent storage device 702, system memory 704 is a read-and-write memory device. However, unlike storage device 702, system memory 704 is a volatile read-and-write memory, such as random access memory. System memory 704 stores any of the instructions and data that processing unit(s) 712 needs at runtime. In one or more implementations, the processes of the subject disclosure are stored in system memory 704, permanent storage device 702, and/or ROM 710. From these various memory units, processing unit(s) 712 retrieves instructions to execute and data to process in order to execute the processes of one or more implementations.

Bus 708 also connects to input and output device interfaces 714 and 706. Input device interface 714 enables a user to communicate information and select commands to the electronic system. Input devices used with input device interface 714 include, for example, alphanumeric keyboards and pointing devices (also called “cursor control devices”). Output device interface 706 enables, for example, the display of images generated by electronic system 700. Output devices used with output device interface 706 include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to a user or device can be any form of sensory feedback, such as visual feedback, auditory feedback, or tactile feedback; and input from the user or device can be received in any form, including acoustic, speech, or tactile input.

As shown in FIG. 7, bus 708 also couples electronic system 700 to a network (not shown) through network interface 716. In this manner, the computer can be a part of a network of computers (such as a local area network (“LAN”), a wide area network (“WAN”), or an Intranet, or a network of networks, such as the Internet. Any or all components of electronic system 700 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In some implementations, the tangible computer-readable storage medium can be directly coupled to a computing device, while in other implementations, the tangible computer-readable storage medium can be indirectly coupled to a computing device, for example, via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

In one or more implementations, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more implementations are performed by one or more integrated circuits, such as application specific integrated circuits (ASICs) or field programmable gate arrays (FPGAs). In one or more implementations, such integrated circuits execute instructions that are stored on the circuit itself.

Those of skill in the an would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g. arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An integrated circuit for processing audio/video (AV) data, the integrated circuit comprising circuitry configured to:
encrypt a first received AV data unit;
generate a first network packet for the first encrypted AV data unit at least partially contemporaneous with encryption of a second AV data unit by the integrated circuit;
provide the first network packet for transport over a network; and
encrypt the first received AV data unit at least partially contemporaneous with generation of a second network packet by the integrated circuit;
wherein the first and second AV data units are encrypted and the first network packet is generated without accessing memory external to the integrated circuit.

2. The integrated circuit of claim 1, the integrated circuit comprising circuitry configured to:
receive a number of AV data units, the number of AV data units including the first and the second AV data unit;
consecutively encrypt the number of AV data units based at least in part on a copy protection scheme;
associate the encrypted AV data units with a security header, the security header being generated before the AV data units are encrypted, and the security header including information related to the copy protection scheme;
generate a plurality of network packets for transport of the encrypted AV data units and the associated security header based at least in part on an order in which the AV data units are encrypted, the plurality of network packets comprising the first and second network packets, one or more of the plurality of network packets being generated contemporaneous with encrypting one or more of the AV data units; and
provide the plurality of network packets for transport to a client device as the plurality of network packets are generated.

3. The integrated circuit of claim 2, wherein the security header associated with the encrypted AV data units is transported in only one of the plurality of network packets generated for the transport of the encrypted AV data units.

4. The integrated circuit of claim 2, the circuitry further configured to:
generate a plurality of network packet headers for the plurality of network packets prior to the encrypting of the AV data units, each of the plurality of network packet headers providing information about a corresponding network packet; and
align the plurality of network packet headers at locations throughout the encrypted AV data units, a group of the encrypted AV data units forming one of the plurality of network packets when the group of the encrypted AV data units is accumulated at a position associated with one of the plurality of network packet headers that corresponds to the one of the plurality of network packets.

5. The integrated circuit of claim 2, wherein each AV data unit includes one or more blocks of AV data, wherein consecutively encrypting the number of AV data units includes chain encrypting a plurality of blocks of AV data spanning at least one AV data unit.

6. The integrated circuit of claim 5, wherein the plurality of blocks of AV data spans multiple AV data units, the circuitry further configured to:
encrypt all but a first partial block of AV data in a first AV data unit;
store the first partial block in a buffer;
receive a second AV data unit comprising a second partial block of AV data;
combine the first partial block and the second partial block to form a complete data block; and
encrypt the complete data block based at least in part on the copy protection scheme.

7. The integrated circuit of claim 1, the circuitry further configured to:
identify related AV data units within a plurality of different data streams;
coalesce the related AV data units into a single multiplexed stream of AV data units, the multiplexed stream including the number of AV data units; and
provide the multiplexed stream for the consecutive encrypting of the number of AV data units.

8. The integrated circuit of claim 7, the circuitry further configured to:
receive encoded data from one or more encoders, wherein the plurality of different data streams are received into encoder buffers from the one or more encoders, the related AV data units being identified within different encoder buffers.

9. The integrated circuit of claim 8, wherein the plurality of data streams are received in real-time from a multimedia broadcast, and the related AV data units being selected from the encoder buffers to form the single multiplexed stream of AV data.

10. The integrated circuit of claim 1, the integrated circuit further configured to:
chunk encode a stream of encrypted AV data units, chunk headers being inserted within the stream at locations corresponding to respective chunked portions of the stream, wherein the plurality of network packets are generated for transport of a chunked portion comprising the encrypted AV data units and the security header.

11. A method for encrypting and packaging audio/video (AV) data for transport in a network, the method comprising:
consecutively encrypting a number of AV data units of an AV payload based at least in part on a copy protection scheme;
associating the AV payload with a security header, the security header being generated before the AV data units of the AV payload are encrypted and the security header including information related to the copy protection scheme;
consecutively generating a plurality of network packets for transport of the encrypted AV data units and the security header of the AV payload based on an order in which the AV data units are encrypted; and
providing the plurality of network packets for transport to a client device as the plurality of network packets are generated, wherein a first network packet of the plurality of network packets comprising a first portion of the encrypted AV data units of the AV payload and the security header is provided for transport contemporaneous with generating a second network packet of the plurality of network packets for transport of a second portion of the encrypted AV data units of the AV payload.

12. The method of claim 11, wherein the first network packet of the plurality of network packets comprising the first portion of the encrypted AV data units of the AV payload and the security header is provided for transport contemporaneous with consecutively encrypting a third portion of the AV data units of the AV payload, and wherein the security header is only transported in the first network packet of the plurality of network packets.

13. The method of claim 1, further comprising:
generating a plurality of network packet headers for the network packets prior to the encrypting of the AV data units, a packet header providing information about a corresponding network packet,
wherein the plurality of network packet headers are aligned at locations throughout the encrypted AV data units, a group of the encrypted AV data units forming a network packet when the group of the encrypted AV data units is accumulated at a position associated with a network packet header for the network packet.

14. The method of claim 11, wherein each AV data unit includes one or more blocks of AV data, wherein consecutively encrypting the number of AV data units includes chain encrypting a plurality of blocks of AV data spanning at least one AV data unit.

15. The method of claim 14, wherein the number of AV data units are encrypted by consecutively encrypting one block of AV data at a time.

16. The method of claim 15, wherein the plurality of blocks of AV data spans multiple AV data units, the method further comprising:
encrypting all but a first partial block of AV data in a first AV data unit;
storing the first partial block in a buffer;
receiving a second AV data unit comprising a second partial block of AV data;
combining the first partial block and the second partial block to form a complete data block; and
encrypting the complete data block based on the copy protection scheme.

17. The method of claim 11, further comprising:
identifying related AV data units within a plurality of different data streams;
coalescing the related AV data units into a single multiplexed stream of AV data units, the multiplexed stream including the number of AV data units; and
providing the multiplexed stream for the consecutive encrypting of the number of AV data units.

18. The method of claim 17, further comprising:
receiving the plurality of different data streams from one or more encoders into a plurality of encoder buffers, the related AV data units being identified within different encoder buffers.

19. The method of claim 18, further comprising:
receiving the plurality of data streams in real-time from a multimedia broadcast, the related AV data units being selected from the encoder buffers by a processor to form the single multiplexed stream of AV data.

20. A computer program product comprising instructions stored in a tangible computer-readable storage medium, the instructions comprising:
instructions for encrypting a plurality of data units, consecutively, based at least in part on a security mechanism;
instructions for associating the encrypted plurality of data units with a security header, the security header being generated before the plurality of data units are encrypted and the security header including information related to the security mechanism;
instructions for generating a plurality of Ethernet packets, consecutively, for transport of the encrypted plurality of data units and the associated security header based at least in part on an order in which the plurality of data units are encrypted, wherein the security header is exclusively included in a first Ethernet packet of the plurality of Ethernet packets; and
instructions for providing the plurality of Ethernet packets for transport to a client device as the plurality of Ethernet packets are generated, wherein the first Ethernet packet of the plurality of Ethernet packets that comprises the security header and a first portion of the encrypted plurality of data units is provided for transport to the client device contemporaneous with generating a second Ethernet packet of the plurality of Ethernet packets for transport of a second portion of the encrypted plurality of data units.
